(19) United States
(12) Patent Application Publication
(10) Pub. No.: US 2024/0370506 A1
(43) Pub. Date: Nov. 7, 2024

(54) DETERMINING GENEALOGICAL RECORDS FOR RECORD QUERIES UTILIZING A LIFESPAN FILTER ALGORITHM

(71) Applicant: Ancestry.com Operations Inc., Lehi, UT (US)

(72) Inventors: Gann Bierner, Oakland, CA (US); Robert Weis, Oakland, CA (US)

(21) Appl. No.: 18/647,603

(22) Filed: Apr. 26, 2024

Related U.S. Application Data
(60) Provisional application No. 63/499,595, filed on May 2, 2023.

(51) Int. Cl. G06F 16/9535

(52) U.S. Cl. CPC G06F 16/9535

(57) ABSTRACT

The present disclosure is directed toward systems, methods, and non-transitory computer-readable media for utilizing a sophisticated lifespan filter algorithm for searching genealogical databases to accurately identify genealogical records that match a record query. For example, utilizing the lifespan filter algorithm, the disclosed systems can access and analyze data pertaining to relatives of candidate records (e.g., genealogical records that could match a record query). In some cases, for a given candidate record, the disclosed systems access genealogical data fields for a spouse, one or both parents, and/or one or more children of the individual represented by the candidate record. From the relative-data fields, the disclosed systems can determine a record lifespan for the candidate record and can compare the record lifespan with a query lifespan of the record query to determine whether the candidate record matches the record query.

### CROSS-REFERENCE TO RELATED APPLICATIONS

The present application claims priority to, and the benefit of, U.S. Provisional Application No. 63/499,595, titled DETERMINING GENEALOGICAL RECORDS FOR RECORD QUERIES UTILIZING A LIFESPAN FILTER ALGORITHM, filed on May 2, 2023. The aforementioned application is hereby incorporated by reference in its entirety.

### BACKGROUND

Advancements in computing devices and networking technology have given rise to a variety of innovations in cloud-based genealogical data storage, sharing, and generation. For example, online historical content systems can provide access to digital genealogical records across devices all over the world. Existing systems can also analyze genealogical data for specific user accounts to generate links or relationships between accounts and genealogical records. For example, modern historical content systems can provide search functions allowing a user to sift through large quantities of genealogical data to identify relevant genealogical records, including digitized newspaper articles, images, census records, obituaries, court documents, military records, immigration records, and other types of digitized historical documents relevant to the user's search query. Despite these advances, however, existing historical content systems continue to suffer from a number of disadvantages, particularly in terms of query result accuracy.

As just suggested, certain existing historical content systems are inaccurate. More particularly, when identifying relevant genealogical records to surface to client devices, many existing systems apply error-prone algorithms that produce faulty results which include records that do not fit a search query. For example, in response to a search query for genealogical records pertaining to a deceased relative, the error-prone algorithms of some existing systems surface results that include impossible genealogical records for individuals whose lifespan could not possibly fall within the required timeframe to be the indicated relative. Consequently, the search functions of some existing systems generate inaccurate and unreliable results which, in some cases, can lead to corrupted genealogical databases rife with inaccurate data, especially when systems rely on such inaccurate results for incorporating records into databases storing genealogy trees. Additionally, the sheer volume of records that may be returned in relation to a user's search query-which may total in the thousands, tens of thousands, hundreds of thousands, or even millions of records—can be overwhelming to the user; the inclusion of such records in a result set, many of which have middling or no pertinence to the user's purposes for the search query, can reduce the user's engagement with, and the likelihood of rewarding experiences on, the historical content system.

### SUMMARY

This disclosure describes one or more embodiments of systems, methods, and non-transitory computer-readable storage media that provide benefits and/or solve one or more of the foregoing and other problems in the art. In particular, the disclosed systems provide a sophisticated lifespan filter algorithm for searching genealogical databases to accurately identify genealogical records that match a record query. For example, utilizing the lifespan filter algorithm, the disclosed systems can access and analyze data pertaining to relatives of candidate records (e.g., genealogical records that match a record query). In some cases, for a given candidate record, the disclosed systems access genealogical data fields for a spouse, one or both parents, and/or one or more children of the individual represented by the candidate record. From the relative-data fields, the disclosed systems can determine a record lifespan for the candidate record and can compare the record lifespan with a query lifespan of the record query to determine whether the candidate record matches the record query. In embodiments, a user's record query, the record query comprising genealogical parameters for searching a genealogical record database, is received at or from a client device. The genealogical parameters of the record query are utilized to determine, using the lifespan filter algorithm, a query lifespan for the user's record query. A record lifespan for a candidate record of a set of search results corresponding to the user's record query may be determined using the lifespan filter algorithm by analyzing relative-data fields associated with life events of relatives of a target person in the user's record query. Based on a comparison between the query lifespan and the record lifespan, the candidate record is included in a query result. The query result may be displayed at the client device.

In embodiments, the genealogical parameters of the user's record query include dates associated with life events. The query lifespan and/or the record lifespan may be determined by determining a known-living range, a possibly-living range, a maximum birth date, or a minimum death date from the genealogical parameters of the user's record query. Determining the record lifespan may include determining, using the lifespan filter algorithm, a set of relative lifespans for relatives associated with a candidate record pertaining to the target person, and using the relative lifespans to determine the record lifespan. The comparison between the query lifespan and the record lifespan may include determining that the query lifespan and the record lifespan overlap, and based on the overlap including the candidate record in the query result; where a record lifespan for a candidate record does not overlap with the query lifespan, the candidate record is filtered out and not included in the query result.

A plurality of candidate records may be identified by identifying records that match the record query according to at least one genealogical parameter. A candidate record may include a relative-data field indicating timing data for a life event of a relative of the target individual. A buffer metric may be used for determining the record lifespan, in which an error window for dates of the life events for the target individual's relatives is applied. The record lifespan may be based on a possibly-living range indicating a timespan from an earliest-possible birth year to a latest-possible death year indicated by the life events for the target individual's relatives. A candidate record that is included within a query result comprising a plurality of records may be ordered among the plurality of records based on an amount of overlap between the record and query lifespans for that record. The candidate record may be included in the query result based on a degree of overlap between the record and query lifespans.

In embodiments, a possibly-living range for a relative of the target individual may be determined based on the relative-data fields, with a maximum birth date indicating a latest possible year of birth for the target individual and/or a minimum death rate indicating an earliest possible year of death for the target individual being determined as part of the record lifespan and based on the possibly-living range of the relative.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a lifespan filter system operates in accordance with one or more embodiments.

FIG. 2 illustrates an overview of utilizing a lifespan filter algorithm to generate a query result for a record query in accordance with one or more embodiments.

FIG. 3 illustrates an example diagram for determining a record lifespan for a candidate record based on relative lifespans informed by relative-data fields of a candidate record in accordance with one or more embodiments.

FIG. 4 illustrates an example diagram for determining a record lifespan for a candidate record based on relative lifespans determined from relative records in accordance with one or more embodiments.

FIG. 5 illustrates an example diagram for comparing a record lifespan with a query lifespan in accordance with one or more embodiments.

FIG. 6 illustrates an example diagram for determining a possibly living range for a candidate record based on a parent record in accordance with one or more embodiments.

FIG. 7 illustrates an example diagram for determining a possibly living range for a candidate record based on a spouse record in accordance with one or more embodiments.

FIG. 8 illustrates example diagrams for determining a possibly living range for a candidate record based on a child record in accordance with one or more embodiments.

FIG. 9 illustrates an example diagram for determining a known living range for a candidate record based on a child record in accordance with one or more embodiments.

FIG. 10 illustrates an example query result interface in accordance with one or more embodiments.

FIG. 11 illustrates a flowchart of a series of acts for utilizing a lifespan filter algorithm to generate a query result for a record query in accordance with one or more embodiments.

FIG. 12 illustrates a block diagram of an example computing device for implementing one or more embodiments of the present disclosure.

FIG. 13 illustrates an example environment of a networking system having the lifespan filter system in accordance with one or more embodiments.

### DETAILED DESCRIPTION

This disclosure describes one or more embodiments of a lifespan filter system that can generate query results for a record query using a sophisticated lifespan filter algorithm that incorporates relative-data fields (e.g., from a candidate record) in determining lifespans for candidate records as potential records to include in a query result. In many use cases, user accounts use client devices to search genealogical databases for genealogical records (e.g., digitized newspaper articles, images, census records, obituaries, court documents, military records, immigration records, and other types of digitized historical documents) of a target person/individual to identify family members to link within genealogical trees stored within one or more genealogical tree databases and/or to add genealogical records to existing nodes within genealogical trees. As part of this process, the lifespan filter system can receive record queries and can generate query results that include one or more genealogical records by utilizing a lifespan filter algorithm to filter candidate records and surface those candidate records that match the record query.

To identify and provide relevant genealogical records, the lifespan filter system can determine and compare record lifespans with a query lifespan. For example, the lifespan filter system can determine a query lifespan that defines a possible lifespan of an individual represented by terms or parameters of a record query, i.e. a target individual of a user's search query. In addition, the lifespan filter system can determine a record lifespan that defines a possible lifespan of an individual represented by a candidate record. In addition, the lifespan filter system can compare the query lifespan with a record lifespan of each candidate record identified for the record query. Thus, the lifespan filter system can filter out candidate records that do not match (or overlap to a sufficient degree with) the query lifespan. In some cases, the lifespan filter system determines a lifespan (either a query lifespan or a record lifespan) to include a set of timing information, including a known living range, a possibly living range, a maximum birth date (or year), and/or a minimum death date (or year).

As part of determining a record lifespan, in some embodiments, the lifespan filter system further determines relative lifespans for relatives associated with a candidate record. To elaborate, the lifespan filter system can identify and analyze, from a candidate record, relative fields that indicate genealogical parameters associated with relatives of an individual represented by a candidate record. For instance, the lifespan filter system can identify dates corresponding to various life events (e.g., birth, marriage, military service, death, etc.) for relatives of a candidate record, such as a spouse, a parent, or a child of the target individual.

The lifespan filter system can thus utilize the relative-data fields to determine relative lifespans for the spouse(s), child (ren), and/or parent(s). Like a record lifespan, the lifespan filter system can determine a relative lifespan to include a set of timing information, including a known-living range, a possibly-living range, a maximum birth date (or year), and/or a minimum death date (or year). Additionally, the lifespan filter system can utilize the relative lifespans to refine or determine a record lifespan for the candidate record, where the relative lifespans inform the determination of the record lifespan based on particular life events and corresponding dates.

In some embodiments, to inform the determination of relative lifespans, the lifespan filter system can identify separate relative records associated with individuals defined as relatives (e.g., within a genealogy tree database) of an individual associated with a candidate record. In some embodiments, for each candidate record, the lifespan filter system analyzes a genealogy tree to identify one or more spouse nodes, one or more child nodes, and/or one or more parent nodes. From the relative nodes, in some cases, the lifespan filter system further determines or identifies genealogical records for the relatives (e.g., linked to or associated with the relative nodes), where the relative records include parameters for dates associated with various life events of the relatives. In embodiments, the lifespan filter system utilizes a cluster database in which like nodes from a plurality of the genealogy trees of the genealogy tree database are identified and resolved together to allow the records and data associated with a node representing a person in one tree to be accessible to and/or via a corresponding node representing the same person in another tree. This advantageously allows for the lifespan filter system to utilize records and data uploaded or saved to a particular tree in determining a relative lifespan for filtering candidate records in a query pertaining to a different tree. Accordingly, the lifespan filter system may utilize a cluster database in conjunction or cooperation with the genealogy tree database for identifying pertinent relative tree nodes among the plurality of genealogy trees that contain a node corresponding to the particular relative(s), retrieving records associated with the pertinent relative tree nodes, and determining on the basis of the information contained in the retrieved records, the relative lifespans for a candidate record.

To determine a query lifespan, the lifespan filter system can analyze genealogical parameters input as part of a record query. For example, the lifespan filter system can receive genealogical parameters in the form of a first name, a last name, and/or one or more dates (e.g., years) corresponding to respective life events, such as birth, death, marriage, military service, and/or immigration. From the genealogical parameters of a record query, the lifespan filter system can determine a query lifespan (including the set of timing information mentioned above) for the record query.

As mentioned, in some embodiments, the lifespan filter system further generates a query result for a record query by identifying one or more candidate records that match or satisfy the genealogical parameters of the record query. For example, the lifespan filter system compares the query lifespan with a record lifespan (which is based in part on relative lifespans) to determine whether a given candidate record matches the record query. The lifespan filter system thus identifies one or more candidate records with record lifespans that, based on the lifespan filter algorithm, correspond to the query lifespan, and the lifespan filter system includes such candidate records within a query result.

As suggested above, the lifespan filter system can provide improvements or advantages over existing historical content systems. For example, the lifespan filter system can improve accuracy over prior systems in generating query results that include genealogical records matching a record query. Indeed, while some prior systems generate inaccurate or unreliable query results that include genealogical records which could not possibly belong to an individual specified by a record query (because the timeline of the record does not overlap with a query timeline), the lifespan filter system utilizes a more sophisticated lifespan filter algorithm to filter out erroneous or impossible candidate records. For instance, by determining and utilizing data pertaining to relatives and relative lifespans as part of determining record lifespans for candidate records, the lifespan filter system implements a more intelligent, more accurate, more robust algorithm than those of prior systems to filter out candidate records and more accurately surface those that satisfy a record query.

As a consequence of generating more accurate query results, the lifespan filter system can further facilitate or produce more reliable (e.g., less corrupted, or less erroneous) genealogical databases. For instance, whereas reliance on the inaccurate query results of some prior systems causes systems (or user accounts) to add faulty nodes (and/or incorrect genealogical records or data linked to nodes) within genealogy tree databases, the more accurate query results of the lifespan filter system can result in cleaner, more accurate, more reliable genealogy tree databases that include fewer faulty nodes (and/or fewer incorrect genealogical records linked to nodes). The lifespan filter system further improves efficiency by reducing a number of record results that are retrieved, ordered, and displayed to a user. Yet further, the lifespan filter system advantageously improves user engagement with the online historical content system such that users are presented with more-pertinent records that facilitate more-effective and emotionally rewarding journeys of genealogical research and personal discovery; rather than inundating users with countless many record results in response to a search query, the lifespan filter system narrows down the results such that the query result is more manageable and more relevant to the user.

In some embodiments, the lifespan filter system utilizes a symmetrical lifespan filter algorithm that facilitates more efficient debugging and updating/upgrading. For example, as opposed to prior systems that use asymmetrical algorithms which require large numbers of client device interactions to interpret and modify, the lifespan filter system can implement a symmetrical lifespan filter algorithm that is easily interpretable, and which therefore requires fewer client device interactions to modify for debugging. Thus, not only is the lifespan filter system more secure and reliable by providing better debugging (which ostensibly results in fewer bugs), the lifespan filter system can also preserve computer resources such as processing power and memory by processing fewer debugging operations and/or algorithm modifications than prior systems.

As illustrated by the foregoing discussion, the present disclosure utilizes a variety of terms to describe features and benefits of the lifespan filter system. Additional detail is hereafter provided regarding the meaning of these terms as used in this disclosure. As used herein, the term “genealogical record” refers to a digital object or a digital file that includes information (e.g., genealogical information) interpretable by a computing device (e.g., a client device) to present information to a user. A genealogical record can include a file such as a digital text file, a digital image file, a digital audio file, a webpage, a website, a digital video file, a web file, a link, a digital document file, or some other type of file or digital object. A genealogical record can have a particular file type or file format, which may differ for different types of digital content items (e.g., digital documents. digital images, digital videos, or digital audio files). In some cases, a genealogical record can refer to a content item that includes or depicts historical or genealogical information, such as a digitized birth, marriage, or death record, a digitized newspaper article, a digitized photograph of a relative, a digitized census record, a digitized obituary, a digitized court document, a digitized DNA analysis, or a digitized family tree. In some embodiments, a genealogical record includes a content item selected or identified to surface to a client device, such as a record hint (e.g., a stored genealogical record), a digital story (e.g., a stored genealogical content item or collection of genealogical content items arranged for a particular person, topic, or entity of a genealogical data system), a digital image (e.g., a digitized photograph), a new person hint (e.g., a node to add to a genealogical tree), a member tree hint (e.g., a prediction for correcting a node within a genealogical tree of a user account), or a DNA match (e.g., a record indicating a DNA match of a user account to a relative whose information is stored in a genealogical data system).

In some embodiments, a genealogical record can take the form of a candidate record. As used herein, the term “candidate record” refers to a genealogical record analyzed and compared with a record query to determine whether it matches or satisfies the record query. For example, a candidate record includes a genealogical record including one or more genealogical parameters that match or align with a record query, such as a first name, a last name, a location, and/or years associated with one or more life events (e.g., birth, death, marriage, medical operations, military enlistment, childbirth, immigration, tax payment, census information taken, etc.).

In addition, as used herein, the term “query lifespan” refers to a set of one or more time parameters or time metrics associated with, or determined from, a record query. For example, a query lifespan includes a set of time parameters including a known-living range, a possibly-living range, a maximum birth date (or year), and a minimum death date (or year) for a record query (or associated with an individual indicated by a record query). In some cases, a query lifespan includes a lifespan determined by a lifespan filter algorithm for comparing against record lifespans for determining candidate records that satisfy the genealogical parameters of a record query. A minimum death date/year can refer to the earliest possible date/year an individual could have died. A maximum birth date/year can refer to the latest possible date/year an individual could have been born.

Relatedly, as used herein, the term “record lifespan” refers to a set of one or more time parameters or time metrics associated with, or determined for, a candidate record. For example, a record lifespan includes a set of time parameters including a known-living range, a possibly-living range, a maximum birth date (or year), and a minimum death date (or year) for a candidate record (or associated with an individual indicated by a candidate record). In some cases, a record lifespan includes a lifespan determined by a lifespan filter algorithm for comparing against a query lifespan for determining candidate records that satisfy the genealogical parameters of a record query.

Along these lines, the term “relative lifespan” refers to a set of one or more time parameters or time metrics associated with, or determined for, a relative of a candidate record. For example, a relative lifespan includes a set of time parameters including a known-living range, a possibly-living range, a maximum birth date (or year), and a minimum death date (or year) for a relative (e.g., a spouse, a child, or a parent) of a candidate record (or of an individual indicated by a candidate record). In some cases, a relative lifespan includes a lifespan determined by a lifespan filter algorithm to use as a basis for determining a record lifespan (which is then used to compare with a query lifespan for populating query results).

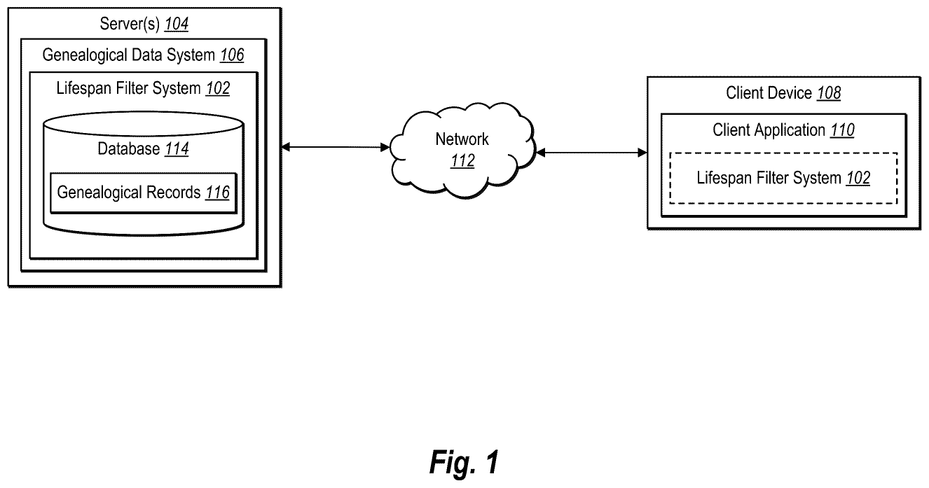

Additional detail regarding the lifespan filter system will now be provided with reference to the figures. For example, FIG. 1 illustrates a schematic diagram of an example system environment for implementing a lifespan filter system 102 in accordance with one or more implementations. An overview of the lifespan filter system 102 is described in relation to FIG. 1. Thereafter, a more detailed description of the components and processes of the lifespan filter system 102 is provided in relation to the subsequent figures.

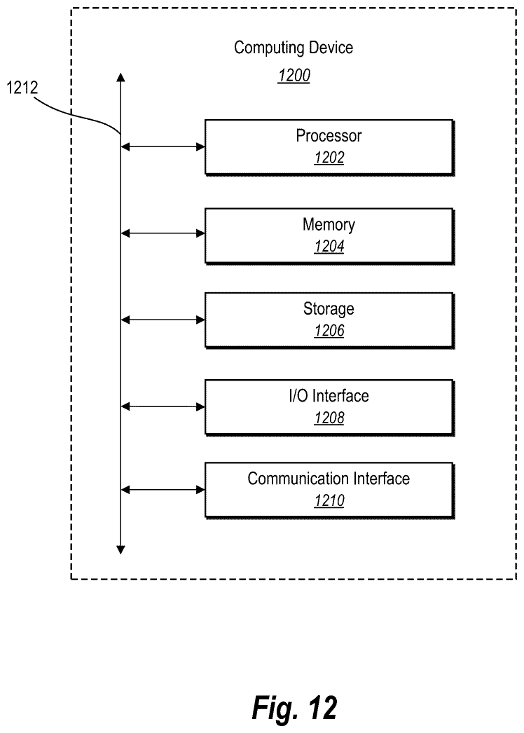

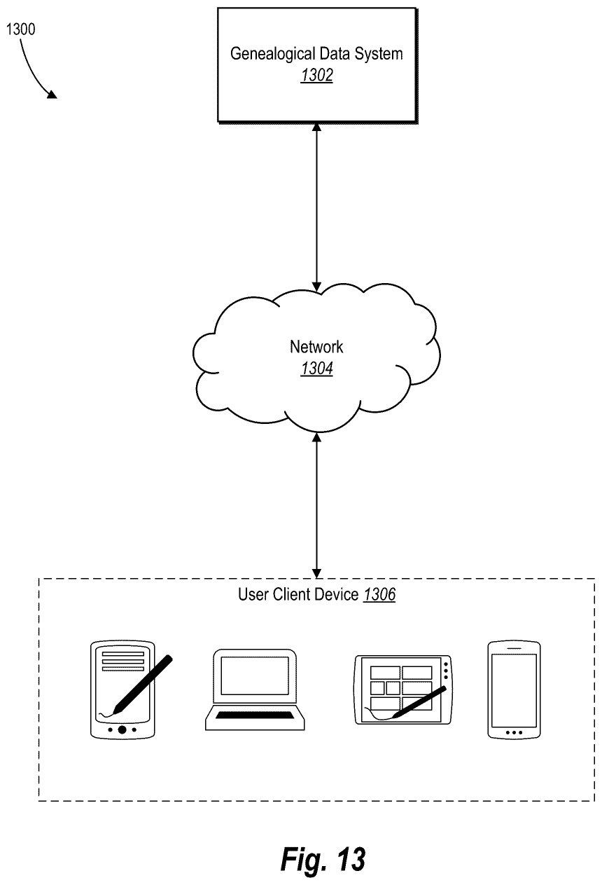

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIGS. 12-13.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 12-13. The client device 108 can communicate with the server(s) 104 and/or the database 114 via the network 112. For example, the client device 108 can receive user input from respective users interacting with the client device 108 (e.g., via the client application 110) to, for instance, search for, access, generate, modify, or share a genealogical record and/or to interact with a genealogy tree or a content item via a graphical user interface of the genealogical data system 106. In addition, the lifespan filter system 102 on the server(s) 104 can receive information relating to various searches for, or interactions with, genealogical records, and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a genealogical record search interface, genealogy tree interface, a discover interface for additional genealogical content, or some other graphical user interface, as described herein.

As illustrated in FIG. 1, the example environment also includes the server(s) 104. The server(s) 104 may generate, track, store, process, receive, and transmit electronic data, such as genealogical records, record queries, query results, and/or interactions with content items. For example, the server(s) 104 may receive data from the client device 108 in the form of an indication of a selection to view a particular graphical user interface or to perform a search for a genealogical record. In addition, the server(s) 104 can transmit data to the client device 108 in the form of a query result within a graphical user interface. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning servers, and other types of servers.

As shown in FIG. 1, the server(s) 104 can also include the lifespan filter system 102 as part of a genealogical data system 106. The genealogical data system 106 can communicate with the client device 108 to perform various functions associated with the client application 110 such as managing user accounts, managing genealogical data, managing genealogy trees, managing genealogical records, and facilitating user interaction with, and sharing of, the genealogy trees and/or genealogical records. Indeed, the genealogical data system 106 can include a network-based cloud storage system to manage, store, and maintain genealogical records and genealogy trees related data user accounts. For instance, the genealogical data system 106 can utilize genealogical data across various content items and user accounts to generate and maintain a universal genealogy tree that reflects the relatedness or consanguinity between nodes corresponding to all user accounts and other individuals indicated by stored genealogical records. In some embodiments, the lifespan filter system 102 and/or the genealogical data system 106 utilize the database 114 to store and access information such as genealogical records, genealogy trees, user account data, and/or other information.

As further illustrated in FIG. 1, the lifespan filter system 102 includes a database 114 that stores genealogical records 116. In particular, the lifespan filter system 102 stores the genealogical records 116 and searches the genealogical records 116 to generate query results in response to record queries. For instance, the lifespan filter system 102 receives a record query from the client device 108 and generates, using a lifespan filter algorithm, a query result that includes one or more records from among the genealogical records 116.

Although FIG. 1 depicts the lifespan filter system 102 located on the server(s) 104, in some implementations, the lifespan filter system 102 may be implemented by (e.g., located entirely or in part on) one or more other components of the environment. For example, the lifespan filter system 102 may be implemented in whole or in part by the client device 108. For example, the client device 108 and/or a third-party system can download all or part of the lifespan filter system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the lifespan filter system 102, bypassing the network 112. As another example, the environment may include multiple client devices, each associated with a different user account. In addition, the environment can include the database 114 located external to the server(s) 104 (e.g., in communication via the network 112) or located on the server(s) 104 and/or on the client device 108.

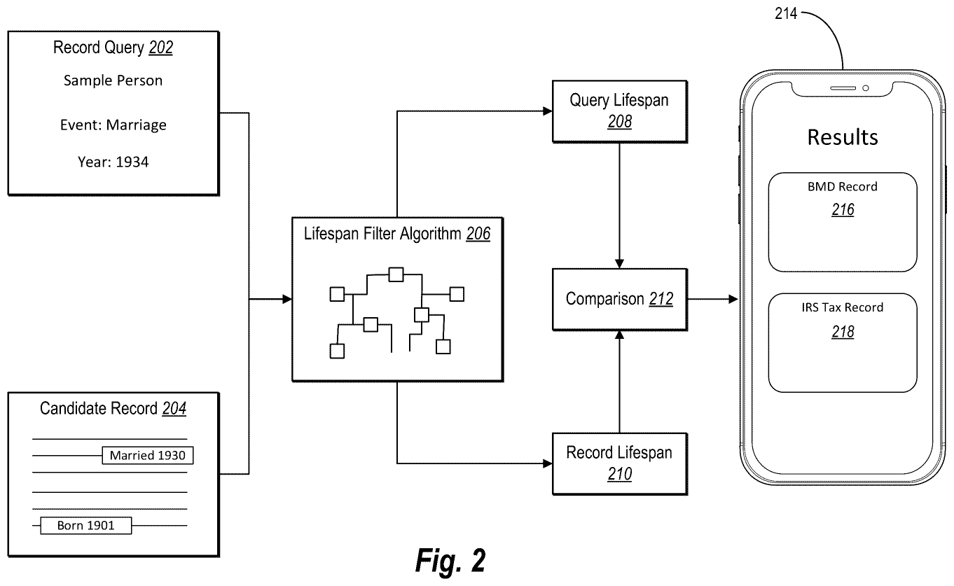

As mentioned above, the lifespan filter system 102 can generate a query result that includes one or more candidate records that match or align with genealogical parameters of a record query. In particular, the lifespan filter system 102 can utilize a lifespan filter algorithm to identify candidate records that align with a record query. FIG. 2 illustrates an example overview diagram of utilizing a lifespan filter algorithm to generate a query result in accordance with one or more embodiments. Additional detail regarding the various acts and methods mentioned in FIG. 2 is provided thereafter with reference to subsequent figures.

As illustrated in FIG. 2, the lifespan filter system 102 accesses or receives a record query 202. In particular, the lifespan filter system 102 receives the record query 202 from a client device (e.g., the client device 214), where the record query 202 includes one or more genealogical parameters. As shown, the lifespan filter system 102 determines genealogical parameters for the record query 202, including a first name (“Sample”) and a last name (“Person”), a life event (“Marriage”) and a year associated with the life event (1934).

As also illustrated in FIG. 2, the lifespan filter system 102 accesses or identifies a candidate record 204. More specifically, the lifespan filter system 102 identifies, among a plurality of candidate records stored within a genealogical database, a candidate record 204 that matches or aligns with one or more genealogical parameters of the record query 202. For instance, comparing to the record query 202, the lifespan filter system 102 determines the candidate record 204 comprises at least one matching name (or a name within a threshold similarity) and/or at least one matching event (where the dates align or are within a threshold duration of one another). In some cases, the lifespan filter system 102 only selects candidate records that match the first name and/or the last name of the record query 202 as candidate records to pass to a lifespan filter algorithm 206 for further comparing lifespans.

Indeed, as illustrated in FIG. 2, the lifespan filter system 102 utilizes the lifespan filter algorithm 206 to process or analyze the record query 202 to determine a query lifespan 208. To elaborate, the lifespan filter system 102 determines the query lifespan 208 by determining a known-living range, a possibly-living range, a maximum birth date, and/or a minimum death date from the genealogical parameters associated with the record query 202. For example, the lifespan filter system 102 determines a possibly-living range for the record query 202 by determining time duration from an earliest possible birth date (or year) to a latest possible death date (or year), as indicated by years associated with particular life events.

As shown, the record query 202 indicates that Sample Person was married in 1934, and the lifespan filter system 102 thus determines that Sample Person was not only alive in 1934 but also that Sample Person was at least marriage-able age in 1934 (e.g., 10 years old or 18 years old or some other threshold age as determined by the lifespan filter system 102, which may be dynamic based on locations and/or time periods with which the candidate record and/or record query are associated). Accordingly, the lifespan filter system 102 can further determine that Sample Person was born no later than 1924 (or the married date minus the marriage-able age) and that, therefore, Sample Person could have died (or will die) by 2034—based on a preset lifespan or duration for an individual at 100 years (or some other present lifespan).

In some cases, the lifespan filter system 102 utilizes a buffer metric to account for potential approximations or errors in genealogical parameters entered for the record query 202. For instance, the lifespan filter system 102 utilizes a buffer metric of five years (or some other number) in either direction of a life event, to determine that the marriage event occurred anywhere from 1929 to 1939. Accordingly, the lifespan filter system 102 can determine a possibly-living range for Sample person from 1919 (1929 minus the marriage-able age) to 2039 (1939 plus 100 years). In some embodiments, the lifespan filter system 102 utilizes different buffer metrics for different life events or genealogical parameters, such as a buffer metric of five years for birth dates and two years for other life events. For example, the lifespan filter system 102 utilizes a buffer metric on a field used to determine or calculate a lifespan, such as a birth date field, a marriage date field, or a date of another life event.

In addition, the lifespan filter system 102 utilizes the lifespan filter algorithm to process or analyze the candidate record 204 to determine a record lifespan 210. In particular, the lifespan filter system 102 determines the record lifespan 210 based on genealogical parameters identified within the candidate record 204. For instance, the lifespan filter system 102 analyzes or accesses information about the candidate record 204 to determine years for life events associated with the individual (e.g., the candidate with the same name of “Sample Person”) of the candidate record 204. The lifespan filter system 102 may comprise or utilize suitable modalities such as optical character recognition (“OCR”), named entity recognition and/or relation extraction, and/or any other suitable modality for retrieving a genealogical record and assessing the content thereof.

As shown, the lifespan filter system 102 determines that the individual of the candidate record 204 was born in 1901 and married in 1930. Accordingly, the lifespan filter system 102 utilizes the lifespan filter algorithm 206 to determine a possibly-living range for the candidate record 204 (or for the individual of the candidate record 204) from 1901 (e.g., without a buffer metric because the record reflects a date of 1901) to 2006 (e.g., 1901 plus a five-year buffer metric plus 100 years for a preset lifespan). In certain embodiments, the lifespan filter system 102 can utilize a buffer metric even for dates indicated in the candidate record by, for instance, determining a possibly living range from 1896 (five years—or some other buffer metric duration-before the indicated birth year) to 2006. In some cases, the lifespan filter system 102 utilizes a standard time duration for a preset lifespan (e.g., 100 years or some other number of years) to account for a likely lifespan of an individual (so as not to exclude records that might match the record query 202).

As mentioned, in some cases, the lifespan filter system 102 utilizes a buffer metric for time parameters of the query lifespan 208 and/or the record lifespan 210. For example, the lifespan filter system 102 applies a buffer metric to years associated with various life events to account for potential error or approximation in genealogical records and entered queries (e.g., +/−five years of a birth date, a marriage date, a date of child birth, or a date of another life event). Thus, in some embodiments, the lifespan filter system 102 determines a possibly-living range that includes a buffer metric of five years (or some other number of years) earlier than an earliest possible birth year and a buffer metric of five years (or some other number of years) later than a latest-possible death year. Likewise, the lifespan filter system 102 can utilize a buffer metric for a known-living range, a maximum birth date, and/or a minimum death date to account for potential error or estimation within record queries and candidate records (e.g., because historical documents such as genealogical records are sometimes only approximate rather than exact, because of possible errors in OCR-derived information even from accurate historical documents, because of the misrecollections of users who have uploaded content regarding an individual, or otherwise).

In one or more embodiments, the lifespan filter system 102 utilizes the lifespan filter algorithm 206 to determine the query lifespan 208 and the record lifespan 210 according to the following pseudo code:

```
  function boolean consistentLifespans(lifespan1, lifespan2)
    if lifespan1.hasKnown
      then return contains(lifespan2.possible, lifespan1.known)
    else
      return lifespan2.possibleMin <= lifespan1.maxBirth
      AND
      lifespan2.possibleMax >= lifespan1.minDeath
  consistentLifespans(query.lifespan, document.lifespan)
  AND
  consistentLifespans(document.lifespan, query.lifespan)
where “document” represents the candidate record 204, “document.lifespan” represents a record
lifespan, and where “query” represents the record query 202.
```

As further illustrated in FIG. 2, the lifespan filter system 102 performs a comparison 212 to compare the query lifespan 208 and the record lifespan 210. More particularly, the lifespan filter system 102 compares the query lifespan 208 with the record lifespan 210 to determine whether the two lifespans overlap and, if so, to what extent they overlap. For instance, the lifespan filter system 102 determines an overlapping span (e.g., a number of overlapping years) shared by both the query lifespan 208 and the record lifespan 210. The lifespan filter system 102 can perform such a comparison using the algorithm of the lifespan filter algorithm 206 above.

Based on the comparison, the lifespan filter system 102 can filter out or select the candidate record 204 to include within a query result. For instance, the lifespan filter system 102 can select candidate records whose record lifespans are valid candidates for corresponding with a record query according to the lifespan filter algorithm 206. In some embodiments, the lifespan filter system 102 repeats the process illustrated in FIG. 2 for a plurality of candidate records identified via an initial search to identify one or more candidate records that match or align with the record query 202. Specifically, the lifespan filter system 102 identifies candidate records with record lifespans that align with the query lifespan 208 according to the lifespan filter algorithm 206. As shown, the lifespan filter system 102 further generates a query result that includes a first candidate record 216 (“BMD Record”) and a second candidate record 218 (“IRS Tax Record”) that are both determined to be genealogical records for “Sample Person” based on the lifespan filter algorithm 216. The lifespan filter system 102 further provides the query result for display on the client device 214 in response to receiving the record query 202.

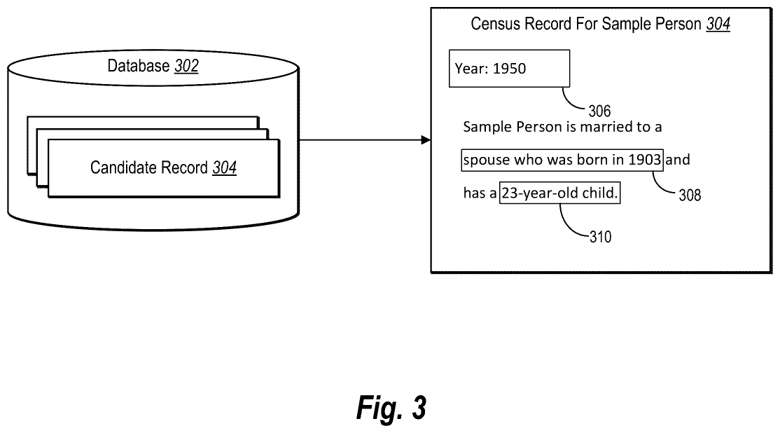

As mentioned above, in certain embodiments, the lifespan filter system 102 determines a record lifespan for a candidate record as a basis for generating a query result including the candidate record. In particular, the lifespan filter system 102 determines a record lifespan from data indicated by relative-data fields populated with data indicating timing information for life events associated with relatives of an individual corresponding to the candidate record. FIG. 3 illustrates an example diagram for determining a record lifespan for a candidate record based on relative lifespans informed by relative-data fields of a candidate record in accordance with one or more embodiments.

As illustrated in FIG. 3, the lifespan filter system 102 analyzes a candidate record 304 from a database 302 of genealogical records. Indeed, the lifespan filter system 102 accesses the database 302 which stores genealogical records from which a query result is populated or generated. In embodiments, a plurality of candidate records 304 are identified in a preliminary search using the record query and/or parameters thereof to identify potentially relevant records from the database 302. As part of the process for generating a query result, the lifespan filter system 102 analyzes the candidate record 304 to identify life events and corresponding timing data for the life events included in the candidate record 304. As shown, the lifespan filter system 102 analyzes a census record for Sample Person to determine known data about Sample Person (about the candidate record directly) as well as to determine possible, ascribed, or attributed data about Sample Person determined or derived from relative data. As mentioned above, the lifespan filter system 102 may utilize any suitable modality, including rules-based or machine-learned approaches for retrieving and assessing data from the record, e.g. OCR, entity extraction and relation detection, etc.

For instance, in addition to data field 306 which indicates a census year for the candidate record 304, the lifespan filter system 102 identifies a relative-data field 308 that includes timing data for a life event associated with a relative of the target individual corresponding to the candidate record 304 (e.g., a relative of an individual represented by the candidate record 304). As shown, the relative-data field 308 indicates a birthdate for a spouse of Sample Person. In addition, the lifespan filter system 102 analyzes the candidate record 304 to determine the relative-data field 310 that indicates that Sample Person has a 23-year-old child.

From the relative-data fields, the lifespan filter system 102 can utilize a lifespan filter algorithm to determine relative lifespans of the corresponding relatives and can use the relative lifespans to determine a record lifespan of the candidate record 304 (to compare with a query lifespan for populating a query result). For instance, the lifespan filter system 102 determines a possibly-living range for the spouse (and/or the child) to use for updating one or more genealogical parameters of the record lifespan for Sample Person, such as a possibly-living range, a maximum birth date, or a minimum death date. Some of the genealogical parameters from relative records including earliest-possible birth dates, latest-possible death dates, and/or earliest/latest-possible dates for particular life events.

From the spouse birth date of 1903, the lifespan filter system 102 can determine a relative lifespan for the spouse. Indeed, from the indicated age of the child and based on the census year of 1950, (and based on a sex of the spouse) the lifespan filter system 102 can determine a relative lifespan (or a possibly-living range) for the spouse. For instance, if the lifespan filter system 102 determines that the spouse is female, then the lifespan filter system 102 utilizes a maximum birthing age (e.g., 75) to determine an earliest possible birth date of 1950-23 (age of child)—75 (maximum birthing age)=1852 (without a buffer metric). The lifespan filter system 102 further determines a latest possible death date of 1950-23 (age of child)—14 (minimum birthing age)+100 (predefined maximum lifespan)=2013 (without a buffer metric), indicating a relative lifespan of 1852 to 2013 for the spouse. The lifespan filter system 102 can thus update or refine a record lifespan of the candidate record 304 based on the relative lifespan for the spouse.

If the lifespan filter system 102 determines that the spouse is male, then the lifespan filter system does not use a maximum birthing age but may still use a minimum birthing age. Thus, the lifespan filter system 102 can determine an earliest-possible birth date of 1950-23 (age of child)—100 (predefined maximum lifespan)=1827 and a latest-possible death date of 2013 (same as for female) for the spouse. In some cases, the predefined maximum lifespan differs by sex, by year, and/or by geographic region. In certain embodiments, the lifespan filter system 102 also takes additional factors into account, such as the fact that males can have a child up to one year after death while females cannot.

As noted above, in some cases, the lifespan filter system 102 utilizes a buffer metric (e.g., five years) to account for possible error windows in genealogical parameters, such as possible-living start metrics, possible-living end metrics, and/or possible life event dates. For example, the lifespan filter system 102 may add a buffer metric to either end of a predicted record lifespan. Thus, continuing the example of FIG. 3, the lifespan filter system 102 determines a record lifespan from either 1847 to 2018 (female) or 1822 to 2013 (male) by adding a buffer metric to each end of the record lifespans above. Indeed, the lifespan filter system 102 can add buffer metrics to predictions of life event dates, such as a maximum birth date or a minimum death date.

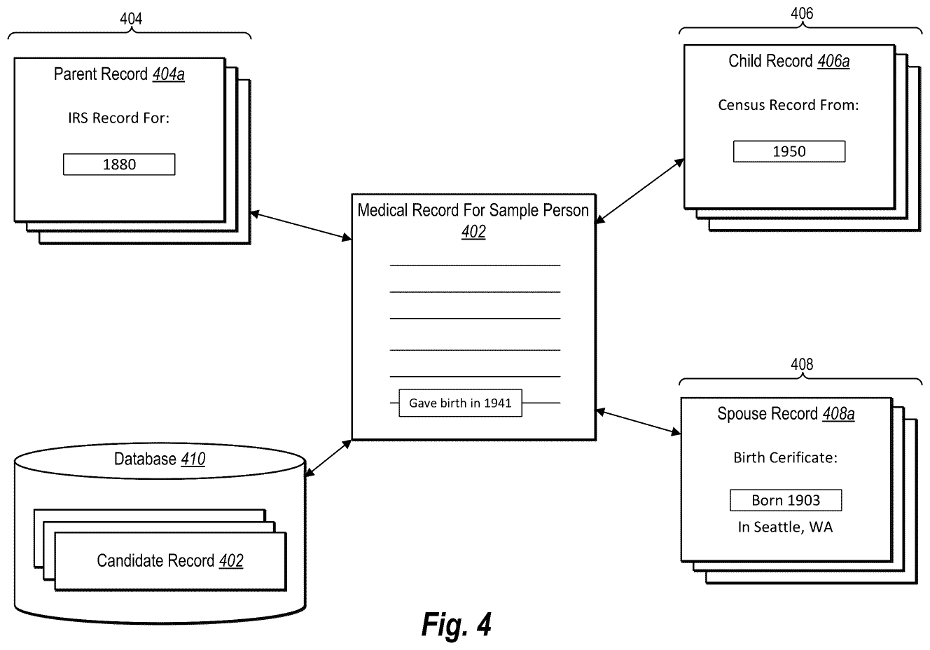

As noted above, in certain embodiments, the lifespan filter system 102 can determine a record lifespan from relative lifespans determined from relative records. In particular, the lifespan filter system 102 can access relative records and can determine relative lifespans of the corresponding relatives as a basis for determining a record lifespan of a candidate record. FIG. 4 illustrates an example diagram for determining a record lifespan for a candidate record based on relative lifespans determined from relative records in accordance with one or more embodiments.

As illustrated in FIG. 4, the lifespan filter system 102 analyzes a candidate record 402 and relative records associated with the candidate record 402. Specifically, the lifespan filter system 102 analyzes parent records 404, child records 406, and spouse records 408. Indeed, the lifespan filter system 102 identifies or accesses the candidate record 402 and the relative records 404, 406, 408 from the database 410. For instance, the lifespan filter system 102 determines one or more parent nodes, one or more child nodes, and/or one or more spouse nodes within a genealogy tree associated with the candidate record 402 stored in the database 410. The lifespan filter system 102 further identifies, from the database 410, genealogical records associated with the identified relative nodes as relative records for the candidate record 402. From the relative records, the lifespan filter system 102 can determine relative lifespans for the respective relatives and can further determine a record lifespan for the candidate record 402 based on (one or more of) the relative lifespans.

In embodiments, the lifespan filter system 102 utilizes a cluster database to identify one or more nodes that are pertinent to the candidate record 402 from different genealogy trees. In embodiments, the identified one or more nodes are identified as being relatives of a target person of a record query based on the nodes or a relative thereto being clustered together with a pertinent node based on a suitable entity resolution modality. This advantageously facilitates data and/or records from relatives not known in or from any one single tree to be utilized by the lifespan filter system 102 to assess the suitability of a particular candidate record for a query result.

To elaborate, the lifespan filter system 102 determines a relative lifespan for a parent represented by a parent record 404a (or by a combination of the parent records 404). For example, the lifespan filter system 102 analyzes the parent record 404a (an IRS record) to determine a tax year of 1880. From the parent record 404a, the lifespan filter system 102 determines that the parent of Sample Person was alive and at least a minimum tax-able age in the year 1880. In some cases, the lifespan filter system 102 determines the minimum tax-able age (and other threshold ages described herein, such as marriage-able ages) based on record data and/or laws from different years, eras, or regions associated with genealogical records. Thus, the lifespan filter system 102 determines that the parent of the parent record 404a has a latest possible death date of 1880-15 (minimum tax-able age)+100=1965 (without a buffer metric). Because there is likely not a maximum tax-able age in most situations, the lifespan filter system 102 determines an earliest possible birth date for the parent record 404a of 1880-100 (predefined maximum lifespan)=1780. Accordingly, the lifespan filter system 102 determines a relative lifespan for the parent record 404a of 1780 to 1965 (or 1775 to 1970 with a buffer metric of five years).

As also illustrated in FIG. 4, the lifespan filter system 102 can determine a relative lifespan for a child represented by a child record 406a (or by a combination of the child records 406). More particularly, the lifespan filter system 102 determines that the child record 406a is a census record from the 1950 census. Based on the census year data, the lifespan filter system 102 determines that the child was alive in 1950. The lifespan filter system 102 further determines an earliest possible birth date for the child (e.g., 1850) and a latest possible death date for the child (e.g., 2050) to indicate a relative lifespan from 1850 to 2050.

As further illustrated in FIG. 4, the lifespan filter system 102 can determine a relative lifespan for a spouse represented by a spouse record 408a (or by a combination of the spouse records 408). To elaborate, the lifespan filter system 102 analyzes the spouse record 408a to determine that the spouse record 408a is a birth certificate for a spouse of Sample Person that indicates a birth date of 1903 for the spouse. Accordingly, the lifespan filter system 102 determines a relative lifespan for the spouse from the known birth date of 1903 (e.g., from 1903 to 2003).

Based on the relative lifespans of the illustrated relative records, and further based on genealogical parameters indicated in the candidate record 402, the lifespan filter system 102 determines a record lifespan. To elaborate, the lifespan filter system 102 determines a record lifespan for the candidate record 402 based on the genealogical parameter than Sample Person gave birth in 1941, thereby indicating that Sample Person is female, and that Sample Person was between a minimum birthing age (e.g., 14 years) and a maximum birthing age (e.g., 75) in 1941. Based on these data, the lifespan filter system 102 determines a record lifespan, including a possibly living range, a maximum birth year, and/or a minimum death year for Sample Person. In addition, the lifespan filter system 102 updates or modifies a possibly living range, a maximum birth date, and/or a minimum death date based on the relative lifespans of the relative records.

For example, the lifespan filter system 102 updates or determines a possibly-living range (bookended by an earliest possible birth date and a latest possible death date), a maximum birth date, and/or a minimum death date for the candidate record 402 based on the parent record 404a. In some cases, the lifespan filter system 102 implements a lifespan filter algorithm that includes code represented by the following pseudo code:

Parent-Based Update

```
{
  PossibleLivingStart = max(PossibleLivingStart, Parent.PossibleLivingStart +
    Parent.MinAge);
  PossibleLivingEnd = min(PossibleLivingEnd, Parent.PossibleLivingEnd +
    ParentMaxAfterDeath + MAX_LIFESPAN);
  MaxBirthYear = min(MaxBirthYear, Parent.PossibleLivingEnd + Parent.MaxAfterDeath);
  MinDeathYear = max(MinDeathYear, Parent.PossibleLivingStart + Parent.MinAge);
}
```

where PossibleLivingStart represents an earliest-possible birth date for the candidate record 402 (e.g., for Sample Person), PossibleLivingEnd represents a latest-possible death date for the candidate record, Parent.PossibleLivingStart represents an earliest-possible birth date for the parent record 404a, Parent.PossibleLivingEnd represents a latest-possible death date for the parent record 404a, Parent. MinAge represents a minimum age someone can have a child (e.g., a minimum birthing age), Parent.MaxAfterDeath represents a maximum number of years an individual can have a child after death (e.g., one year for father, zero years for mother), and MAX_LIFESPAN represents a predefined maximum lifespan.

In addition, the lifespan filter system 102 updates or determines a possibly-living range, a maximum birth date, and/or a minimum death date for the candidate record 402 based on the child record 406a. In some cases, the lifespan filter system 102 implements a lifespan filter algorithm that includes code represented by the following pseudo code:

Child-Based Update

```
{
  PossibleLivingStart = max(PossibleLivingStart, Child.PossibleLivingStart −
    Parent.MaxAfterDeath − MAX_LIFESPAN);
  PossibleLivingEnd = min(PossibleLivingEnd, Child.PossibleLivingEnd − Parent.MinAge +
    MAX_LIFESPAN);
  MaxBirthYear = min(MaxBirthYear, Child.PossibleLivingEnd − Parent.MinAge,
    Child.KnownLivingStart − Parent.MinAge);
  MinDeathYear = max(MinDeathYear, Child.PossibleLivingStart − Parent.MaxAfterDeath);
}
```

where Child. PossibleLivingStart represents an earliest-possible birth date of the child record 406a, Child.PossibleLivingEnd represents a latest-possible death date for the child record 406a, Child.KnownLivingStart represents a known birth date of the child record 406a (if available), and the other terms are as defined above. In some embodiments, as indicated above, the lifespan filter system 102 can also take into account a predefined maximum threshold birth age for a woman (e.g., 75 years). The lifespan filter system 102 can apply this maximum birthing age for birth records (e.g., based on determining that the relationship between a parent and a child is a biological birth).

In addition, the lifespan filter system 102 updates or determines a possibly-living range, a maximum birth date, and/or a minimum death date for the candidate record 402 based on the spouse record 408a. In some cases, the lifespan filter system 102 implements a lifespan filter algorithm that includes code represented by the following pseudo code:

Spouse-Based Update

```
{
  PossibleLivingStart = max(PossibleLivingStart, Spouse.PossibleLivingStart +
    Marriage.MinAge − MAX_LIFESPAN);
  PossibleLivingEnd = min(PossibleLivingEnd, Spouse.PossibleLivingEnd − Marriage.MinAge
    + MAX_LIFESPAN);
  MaxBirthYear = min(MaxBirthYear, Spouse.PossibleLivingEnd − Marriage.MinAge);
  MinDeathYear = max(MinDeathYear, Spouse.PossibleLivingStart − Marriage.MinAge);
}
```

where Marriage.MinAge represents a minimum threshold marriage-able age (e.g., 14 years), Spouse.PossibleLivingStart represents an earliest-possible birth date of the spouse record 408a, Spouse.PossibleLivingEnd represents a latest-possible death date for the spouse record 408a, and the other terms are as defined above.

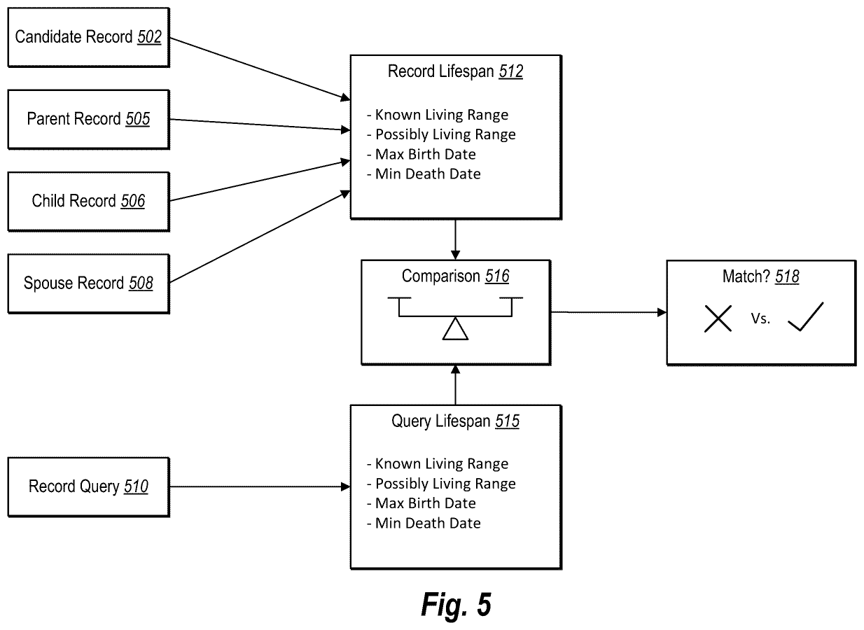

As noted above, in certain described embodiments, the lifespan filter system 102 compares a record lifespan for a candidate record with a query lifespan of a record query to determine whether the candidate record matches a record query. In particular, the lifespan filter system 102 performs such a comparison to filter out candidate records that could not possibly match a record query based on lifespan data. FIG. 5 illustrates an example diagram for comparing a record lifespan with a query lifespan in accordance with one or more embodiments.

As illustrated in FIG. 5, the lifespan filter system 102 determines the record lifespan 512 based on a candidate record 502 and a set of relative records, including a parent record 505, a child record 506, and a spouse record 508. As shown, the record lifespan 512 includes one or more genealogical parameters, including a known-living range, a possibly-living range, a maximum birth date, and/or a minimum death date. In addition, the lifespan filter system 102 compares the record lifespan 512 with a query lifespan 515 to determine whether the candidate record 502 matches the record query 510.

To elaborate, the lifespan filter system 102 determines genealogical parameters that make up the query lifespan 515, including a known-living range, a possibly-living range, a maximum birth date, and/or a minimum death date. For example, the lifespan filter system 102 determines the genealogical parameters based on input received via a client device defining the record query 510. Indeed, the lifespan filter system 102 receives parameters entered as part of the record query 510 to search a database of genealogical records. In some cases, the lifespan filter system 102 provides a search interface that includes fields for entering dates or years to define the genealogical parameters of the record query 510.

As part of the comparison 516, the lifespan filter system 102 determines an amount of overlap (e.g., a number of overlapping years) between the (possibly-living range of the) record lifespan 512 and the (possibly-living range of the) query lifespan 515. In some embodiments, the lifespan filter system 102 also (or alternatively) determines a maximum birth date and/or a minimum death date for the candidate record 502 to compare with a maximum birth date and/or a minimum death date for the record query 510. In some cases, the lifespan filter system 102 determines a maximum birth date and a minimum death date by utilizing a lifespan filter algorithm that includes code for implementing the following formulas:

$$Max Birth = min ( Max Birth , Event \cdot Max Year + BufferMetric )$$

$$and$$

$$Min Death = max ( Min Death , Event \cdot Min Year - BufferMetric - Event \cdot Min Age )$$

where Event. MaxYear represents a maximum year for a particular life event (e.g., marriage, child birth, immigration, or military enlistment), Event. MinAge represents a minimum age of an individual for a particular life event, and Event. MinYear represents a minimum year for a particular life event.

The lifespan filter system 102 can thus determine and compare maximum birth years and/or minimum death years to determine whether the candidate record 502 matches the record query 510. Indeed, the lifespan filter system 102 performs the comparison 516 to compare the record lifespan 512 and the query lifespan 515 to determine whether the candidate record 502 is a match 518 for the record query 510. If the candidate record 502 is a match 518, the lifespan filter system 102 includes the candidate record 502 as part of query result. If not, the lifespan filter system 102 filters out the candidate record 502 and excludes it from a query result.

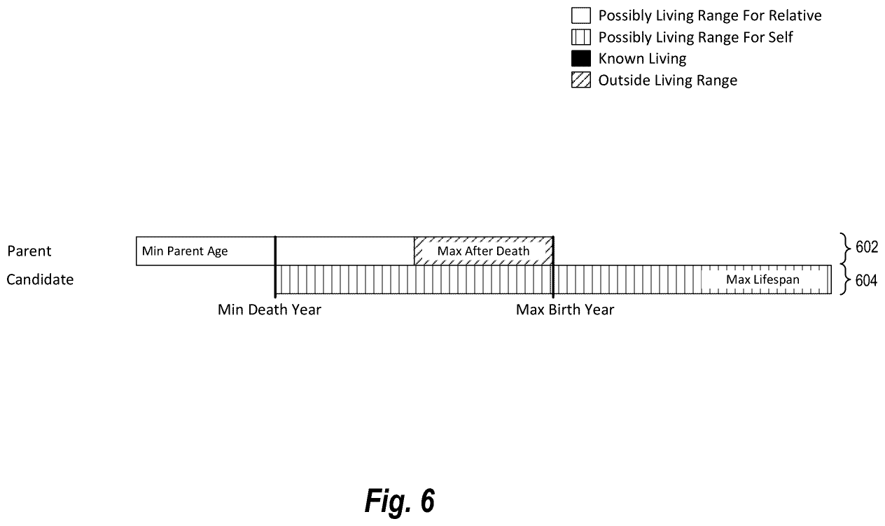

As indicated above, the lifespan filter system 102 utilizes a lifespan filter algorithm that utilizes relative data to account for complicated edge cases for identifying and filtering out candidate records for a record query. For example, the lifespan filter system 102 compares a relative lifespan or a possibly-living range of a parent with a record lifespan of a candidate record. FIG. 6 illustrates an example diagram for determining a possibly-living range (and other genealogical parameters) for a candidate record based on a parent record in accordance with one or more embodiments.

As illustrated in FIG. 6, the candidate timeline 604 corresponds to data of an individual corresponding to one or more candidate records. The parent timeline 602 corresponds to data from a parent record associated with the individual. As shown, the lifespan filter system 102 generates the parent timeline 602 and the candidate timeline 604 to include various sections or components, including known-living ranges, possibly-living ranges, and portions outside of living ranges. The lifespan filter system 102 determines a minimum death year for the candidate timeline 604 as the earliest-possible year of birth (if they die in the same year they are born) for the individual—at an earliest birthing age along the parent timeline 602. In addition, the lifespan filter system 102 determines a maximum birth year for the candidate timeline 604 at a date after the maximum time after parent death that the individual could have been born (one year if the parent is male, zero years of the parent is female).

The lifespan filter system 102 can thus use the minimum death year and the maximum birth year to compare with genealogical parameters of a record query. For instance, the lifespan filter system 102 can receive a record query that indicates a minimum death year and a maximum birth year for a search, and the lifespan filter system 102 can compare the parameters of the query with the minimum death year and the maximum birth year (and other parameters, such as the possibly-living range) determined for the candidate timeline 604. The lifespan filter system 102 can thus determine whether to include or filter out the candidate record corresponding to the candidate timeline 604.

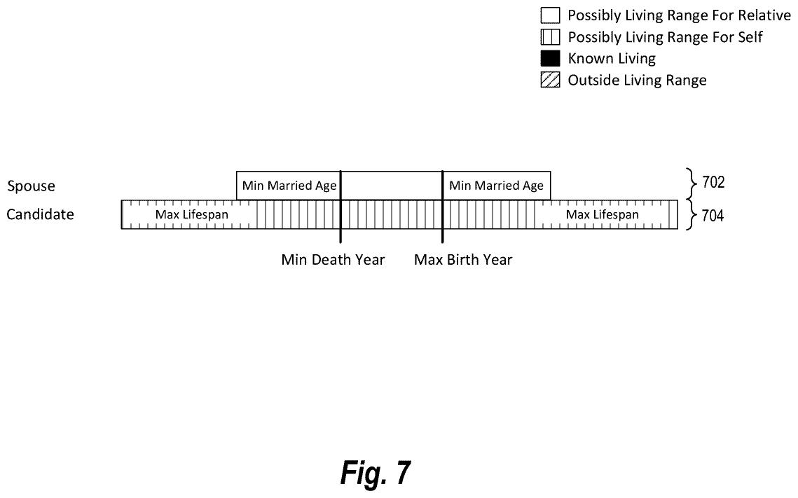

In addition to determining and comparing genealogical parameters for parent records, the lifespan filter system 102 can also determine and compare genealogical parameters for spouse records. In particular, the lifespan filter system 102 can determine dates or years for various life events to generate and compare a spouse timeline with a candidate timeline for determining or filtering query results. FIG. 7 illustrates an example diagram for determining a possibly-living range (and other genealogical parameters) for a candidate record based on a spouse record in accordance with one or more embodiments.

As illustrated in FIG. 7, the lifespan filter system 102 generates a spouse timeline 702 and a candidate timeline 704 to compare with one another. Indeed, the lifespan filter system 102 generates the spouse timeline 702 from one or more spouse records and generates the candidate timeline 704 from one or more candidate records. For example, the lifespan filter system 102 determines a known birth date for the spouse timeline 702. Based on a minimum married age (e.g., 14 years), the lifespan filter system 102 further determines a minimum death year and a maximum birth year for the spouse timeline 702 and the candidate timeline 704—from the birth year of the spouse to the minimum married age. Thus, the lifespan filter system 102 determines the minimum death year as a year 14 years (or some other minimum married age) after the birth year of the spouse. Likewise, the lifespan filter system 102 determines the maximum birth year as a year 14 years before the birth year of the spouse. Additionally, the lifespan filter system 102 determines a possibly-living range for the candidate timeline 704 to include durations before the minimum death year and after the maximum birth year equal to a predefined maximum lifespan.

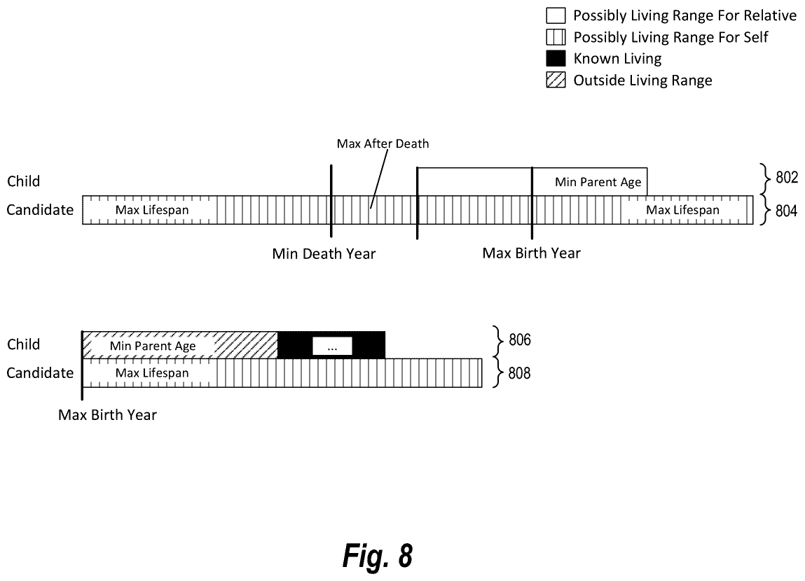

Beyond parents and spouses, the lifespan filter system 102 can also determine and compare genealogical parameters of a candidate record with those of child records. In particular, the lifespan filter system 102 can determine a possibly-living range (or some other genealogical parameters) for a candidate record based on data from one or more child records. FIG. 8 illustrates example diagrams for determining a possibly-living range (and other genealogical parameters) for a candidate record based on a child record in accordance with one or more embodiments.

As illustrated in FIG. 8, the lifespan filter system 102 generates and compares a child timeline 802 and a candidate timeline 804. In particular, the lifespan filter system 102 determines a known birth year for the child timeline 802 and further determines the maximum birth year, the minimum death year, and/or the possibly living range of the candidate timeline 804 based on the known birth year of the child timeline 802. Specifically, the lifespan filter system 102 determines a minimum parent age (e.g., 14 years) and determines the maximum birth year as 14 years before the birth year of the child timeline 802.

In addition, the lifespan filter system 102 determines a minimum death year for the candidate timeline 804. For instance, the lifespan filter system 102 determines the minimum death year based on the known birth date of the child and a maximum time after death that the individual could have had a child (e.g., one year for male, zero years for female). As shown, the lifespan filter system 102 thus determines the minimum death year for the candidate timeline 804 based on a sex of the candidate record (if available) and/or based on the maximum time after death that an individual could have a child (if not available). For example, the lifespan filter system 102 determines the minimum death year as one year before the known birth date of the child timeline 802.

From the maximum birth year and the minimum death year, the lifespan filter system 102 determines a possibly-living range for the candidate timeline 804. For instance, the lifespan filter system 102 determines a maximum lifespan before the minimum death year and/or a maximum lifespan after the maximum birth year (and anything in between) as a possibly-living range for the candidate timeline 804.

As further illustrated in FIG. 8, the lifespan filter system 102 generates and compares a child timeline 806 and a candidate timeline 808. To elaborate, the lifespan filter system 102 determines a known-living range for the child timeline 806 (from one or more child records). The lifespan filter system 102 further determines a minimum parent age (e.g., 14 years) for an individual to have a child. Based on the minimum parent age and the known living range for the child timeline 806, the lifespan filter system 102 can generate the candidate timeline 808. Particularly, the lifespan filter system 102 can determine a maximum lifespan extending from the minimum parent age (e.g., 14 years) before the known-living range of the child timeline 806 as a possibly-living range for the candidate timeline 808.

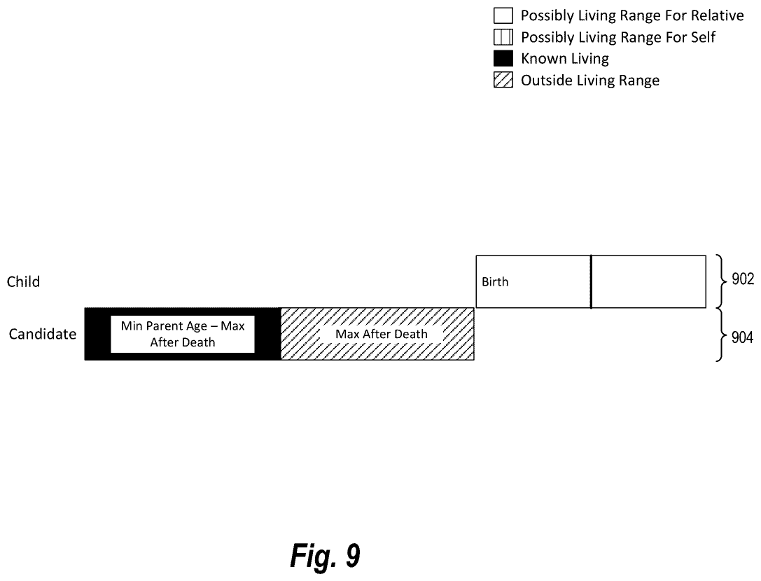

FIG. 9 illustrates another example diagram for determining a known-living range for a candidate record based on a child record in accordance with one or more embodiments. As illustrated in FIG. 9, the lifespan filter system 102 determines a birth date for a child timeline 902 (e.g., as indicated by one or more child records or candidate records). From the birth date, the lifespan filter system 102 further generates information for a candidate timeline 904. Specifically, the lifespan filter system 102 determines a maximum time after death that an individual can have a child (e.g., one year for males, zero years for females) and further determines a difference between a minimum parent age (e.g., 14 years) and the maximum time after death (e.g., 14 years minus 1 year). The lifespan filter system 102 can thus determine a known-living range for the candidate timeline 904 of at least a certain duration (e.g., 13 years) before the known birth date of the child timeline 902.

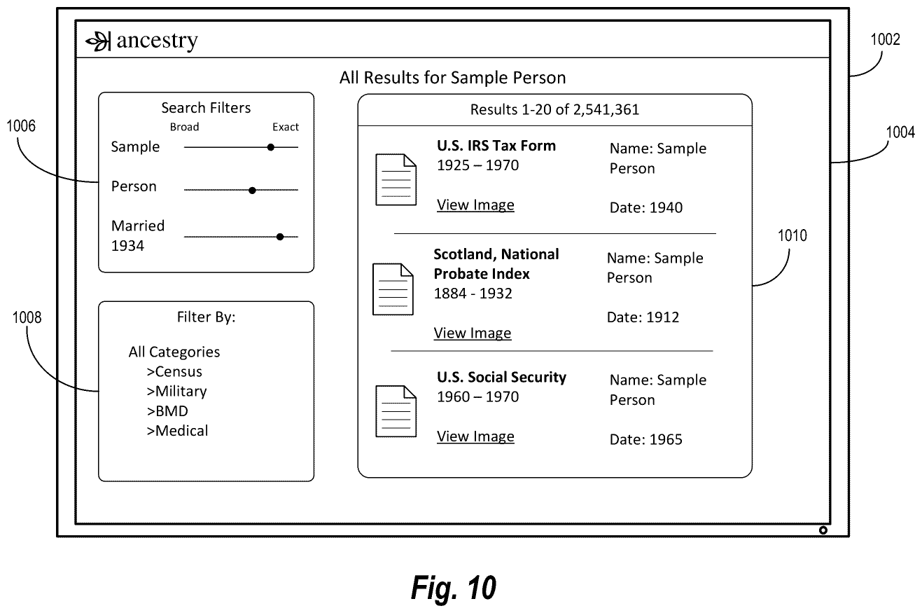

As mentioned above, in certain described embodiments, the lifespan filter system 102 generates and provides a query-result interface for display on a client device. In particular, the lifespan filter system 102 generates a query result to include candidate records with overlapping timelines based on comparing a query lifespan with record lifespans of the candidate records. FIG. 10 illustrates an example query result interface in accordance with one or more embodiments.

As illustrated in FIG. 10, the lifespan filter system 102 generates a query result 1010 for display within the query-result interface 1004, where the query result 1010 includes a number of candidate records. Indeed, the lifespan filter system 102 generates and provides a query-result interface 1004 for display on a client device 1002. Within the query-result interface 1004, the lifespan filter system 102 generates and provides a search filter element 1006 and a record-type filter element 1008. Indeed, the lifespan filter system 102 generates the query-result interface 1004 based on receiving a search query for a particular individual (e.g., “Sample Person”). The lifespan filter system 102 further updates the data shown in the query result interface 1004 based on interactions with the search filter element 1006.

Indeed, the lifespan filter system 102 can receive an interaction to change one or more exactness sliders to change how precisely the lifespan filter system 102 filters candidate records. For instance, the lifespan filter system 102 receives a modification to an exactness slider (or a buffer metric slider) for adjusting a buffer metric (to increase or decrease a duration of the buffer metric) associated with a given name, a surname, and/or a life event date. In some cases, the lifespan filter system 102 receives an input defining (e.g., typing) the life-event type and/or the corresponding date. In response to increasing exactness, the lifespan filter system 102 generates query results that include fewer candidate records based on requiring data fields to align more precisely with the parameters of the search filter element 1006 (e.g., names that match more precisely and/or dates that match more precisely). The lifespan filter system 102 can also filter candidate records according to record type, as indicated by the record-type filter element 1008.

Based on a search query and/or various filter settings, the lifespan filter system 102 thus generates a query result 1010. More specifically, the lifespan filter system 102 generates the query result 1010 to include a set of candidate records based on comparing not only names and life events (according to exactness settings) but also life spans. Indeed, the lifespan filter system 102 determines a query lifespan for a record query (e.g., based on the indicated life event date, an entered known living range, and/or other data) and further determines record lifespans for one or more candidate records as described above.

As shown, the lifespan filter system 102 thus generates the query result 1010 to include candidate records with record lifespans overlapping (or matching) the query lifespan, thereby filtering out candidate records whose record lifespans do not overlap the query lifespan. In some cases, the lifespan filter system 102 further orders the candidate records in the query result 1010 (e.g., from the top down) according to amount (e.g., number of years of) overlap between record lifespans and the query lifespan. This advantageously prioritizes to a user the candidate records most likely to correspond to the target individual. While ordering the candidate records in the query result according to amount of overlap has been described, it will nevertheless be appreciated that the amount of overlap between the record and query lifespans may be utilized as one factor among a plurality of factors for determining a ranking of records in the query result. For example, the amount of overlap between the record and query lifespans may be weighted with factors such as similarity scores between names, locations, existing tree node data, or otherwise as suitable. As shown, the lifespan filter system 102 identifies, as part of the query result 1010, a tax record for a Sample Person from the year 1940, a record from the Scotland National Probate Index from 1912, and a Social Security record from 1965.

The components of the lifespan filter system 102 can include software, hardware, or both. For example, the components of the lifespan filter system 102 can include one or more instructions stored on a computer-readable storage medium and executable by processors of one or more computing devices. When executed by one or more processors, the computer-executable instructions of the lifespan filter system 102 can cause a computing device to perform the methods described herein. Alternatively, the components of the lifespan filter system 102 can comprise hardware, such as a special purpose processing device to perform a certain function or group of functions. Additionally or alternatively, the components of the lifespan filter system 102 can include a combination of computer-executable instructions and hardware.

Furthermore, the components of the lifespan filter system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the lifespan filter system 102 may be implemented as part of a stand-alone application on a personal computing device or a mobile device.

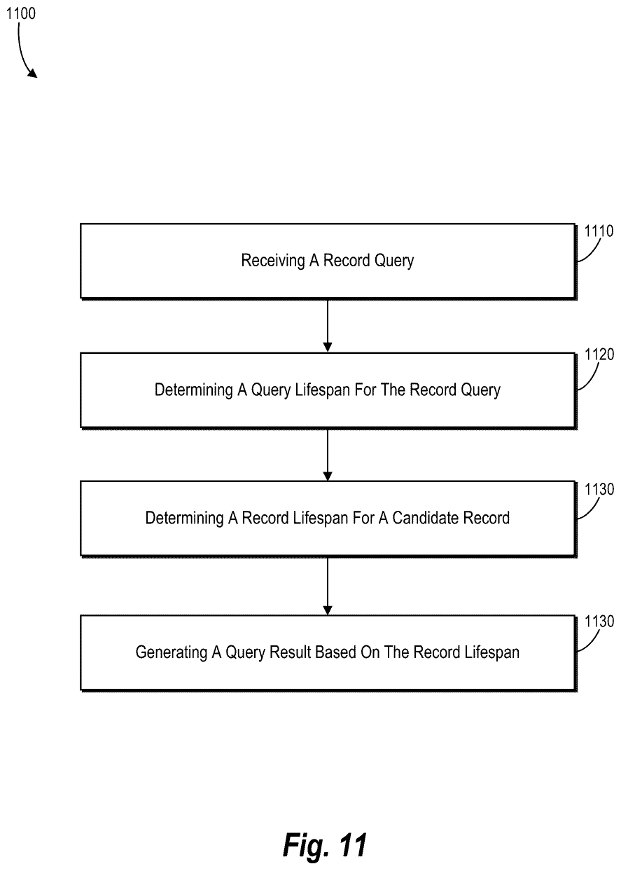

FIGS. 1-10, the corresponding text, and the examples provide a number of different systems and methods for generating and providing query results using a lifespan filter algorithm. In addition to the foregoing, implementations can also be described in terms of flowcharts comprising acts steps in a method for accomplishing a particular result. For example, FIG. 11 illustrate example series of acts for generating and providing query results using a lifespan filter algorithm.

While FIG. 11 illustrates acts according to certain implementations, alternative implementations may omit, add to, reorder, and/or modify any of the acts shown in FIG. 11. The acts of FIG. 11 can be performed as part of a method. Alternatively, a non-transitory computer-readable medium can comprise instructions, that when executed by one or more processors, cause a computing device to perform the acts of FIG. 11. In still further implementations, a system can perform the acts of FIG. 11.

As shown, the series of acts 1100 can include an act 1110 of receiving a record query. In particular, the act 1110 can involve receiving, from a client device, a record query indicating genealogical parameters for searching a genealogical record database. In addition, the series of acts 1120 can include an act 1120 of determining a query lifespan for the record query. In particular, the act 1120 can involve determining, utilizing a lifespan filter algorithm to process the genealogical parameters of the record query, a query lifespan corresponding to the genealogical parameters of the record query. The series of acts 1100 can also include an act 1130 of determining a record lifespan for a candidate record. Particularly, the act 1130 can involve determining, utilizing the lifespan filter algorithm to process a candidate record from a plurality of candidate records stored within the genealogical record database by analyzing relative-data fields indicating dates associated with life events for relatives of the candidate record, a record lifespan corresponding to genealogical parameters of the candidate record. Further, the series of acts 1100 can include an act 1130 of generating a query result based on the record lifespan. For example, the act 1130 can involve generating, based on the query lifespan and the record lifespan, a query result comprising the candidate record to provide to the client device in response to the record query.

The series of acts 1100 can include an act of receiving the record query by receiving a set of genealogical parameters indicating one or more dates associated with one or more life events. In some embodiments, the series of acts 1100 includes an act of determining the query lifespan by utilizing the lifespan filter algorithm to determine one or more of a known living range, a possibly living range, a maximum birth date, or a minimum death date from the genealogical parameters associated with the record query. In certain cases, the series of acts 1100 includes an act of determining the record lifespan by utilizing the lifespan filter algorithm to determine one or more of a known living range, a possibly living range, a maximum birth date, or a minimum death date for the candidate record.

In one or more embodiments, the series of acts 1100 includes an act of determining the record lifespan by utilizing the lifespan filter algorithm to: determine a set of relative lifespans for relatives associated with the candidate record and determine the record lifespan based on the set of relative lifespans. In addition, the series of acts 1100 can include an act of generating the query result by: comparing the query lifespan and the record lifespan according to the lifespan filter algorithm to determine that the query lifespan and the record lifespan overlap and based on determining that the query lifespan and the record lifespan overlap, adding the candidate record to the query result.

The series of acts 1100 can include an act of filtering out from the query result one or more candidate records with record lifespans that do not overlap with the query lifespan as indicated by the lifespan filter algorithm. The series of acts 1100 can also include an act of determining the plurality of candidate records as records stored in the genealogical record database that include at least one matching genealogical parameter with the record query. Further, the series of acts 1100 can include an act of determining the record lifespan by analyzing a relative-data field included within the candidate record, the relative-data field indicating timing data for a life event of a relative of an individual represented by the candidate record.

In some embodiments, the series of acts 1100 includes an act of determining the record lifespan according to a buffer metric indicating an error window for dates of the life events for the relatives of the candidate record. The series of acts 1100 can also include an act of determining the record lifespan based on a possibly living range indicating a timespan from an earliest possible birth year to a latest possible death year indicated by the life events for the relatives of the candidate record. Further, the series of acts 1100 can include an act of ordering the candidate record within the query result based on an amount of lifespan overlap between the record lifespan and the query lifespan.

In some cases, the series of acts 1100 includes an act of providing the query result for display on the client device. The series of acts 1100 can include an act of generating the query result to include the candidate record based on determining that the record lifespan overlaps the query lifespan by at least a threshold amount. Additionally, the series of acts 1100 can include acts of determining a possibly living range of a relative associated with the candidate record based on the relative-data fields and determining, as part of the record lifespan of the candidate record and based on the possibly living range of the relative, a maximum birth date indicating a latest possible year of birth for an individual represented by the candidate record.

In one or more embodiments, the series of acts 1100 includes an act of determining a possibly living range of a relative associated with the candidate record based on the relative-data fields. The series of acts 1100 can also include an act of determining, as part of the record lifespan of the candidate record and based on the possibly living range of the relative, a minimum death date indicating an earliest possible year of death for an individual represented by the candidate record. The series of acts 1100 can also include an act of determining the record lifespan by: determining, from the relative-data fields, a set of relative lifespans for relatives associated with the candidate record and determining the record lifespan based on the set of relative lifespans. Further, the series of acts 1100 can include an act of filtering out, from the query request, one or more candidate records with record lifespans that do not overlap the query lifespan by at least a threshold amount. The series of acts 1100 can also include acts of determining lifespan data of a relative associated with the candidate record based on the relative-data fields and determining, as part of the record lifespan of the candidate record and based on the lifespan data of the relative, one or more of a possibly-living range, a maximum birth date, or a minimum death date.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 (e.g., the server(s) 104 and/or the client device 108) that may be configured to perform one or more of the processes described above. One will appreciate that server(s) 104 and/or the client device 108 may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 13 is a schematic diagram illustrating environment 1300 within which one or more implementations of the lifespan filter system 102 can be implemented. For example, the lifespan filter system 102 may be part of a genealogical data system 1302 (e.g., the genealogical data system 106). The genealogical data system 1302 may generate, store, manage, receive, and send digital content (such as genealogical content items). For example, genealogical data system 1302 may send and receive digital content to and from client devices 1306 by way of network 1304. In particular, genealogical data system 1302 can store and manage genealogical databases for various user accounts, historical records, and genealogy trees. In some embodiments, the genealogical data system 1302 can manage the distribution and sharing of digital content between computing devices associated with user accounts. For instance, the genealogical data system 1302 can facilitate a user account sharing a genealogical content item with another user account of genealogical data system 1302.

In particular, the genealogical data system 1302 can manage synchronizing digital content across multiple client devices 1306 associated with one or more user accounts. For example, a user may edit a digitized historical document or a node within a genealogy tree using client device 1306. The genealogical data system 1302 can cause client device 1306 to send the edited genealogical content to the genealogical data system 1302, whereupon the genealogical data system 1302 synchronizes the genealogical content on one or more additional computing devices.

As shown, the client device 1306 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 1306 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1304.

The network 1304 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1306 may access genealogical data system 1302.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device, a record query indicating genealogical parameters for searching a genealogical record database;
determining, utilizing a lifespan filter algorithm to process the genealogical parameters of the record query, a query lifespan corresponding to the genealogical parameters of the record query;
determining, utilizing the lifespan filter algorithm to process a candidate record from a plurality of candidate records stored within the genealogical record database by analyzing relative-data fields indicating dates associated with life events for relatives of the candidate record, a record lifespan corresponding to genealogical parameters of the candidate record; and
generating, based on the query lifespan and the record lifespan, a query result comprising the candidate record to provide to the client device in response to the record query.

2. The computer-implemented method of claim 1, wherein receiving the record query comprises receiving a set of genealogical parameters indicating one or more dates associated with one or more life events.

3. The computer-implemented method of claim 1, wherein determining the query lifespan comprises utilizing the lifespan filter algorithm to determine one or more of a known-living range, a possibly-living range, a maximum birth date, or a minimum death date from the genealogical parameters associated with the record query.

4. The computer-implemented method of claim 1, wherein determining the record lifespan comprises utilizing the lifespan filter algorithm to determine one or more of a known-living range, a possibly-living range, a maximum birth date, or a minimum death date for the candidate record.

5. The computer-implemented method of claim 1, wherein determining the record lifespan comprises utilizing the lifespan filter algorithm to:
determine a set of relative lifespans for relatives associated with the candidate record; and
determine the record lifespan based on the set of relative lifespans.

6. The computer-implemented method of claim 1, wherein generating the query result comprises:
comparing the query lifespan and the record lifespan according to the lifespan filter algorithm to determine that the query lifespan and the record lifespan overlap; and
based on determining that the query lifespan and the record lifespan overlap, adding the candidate record to the query result.

7. The computer-implemented method of claim 1, further comprising filtering out from the query result one or more candidate records with record lifespans that do not overlap with the query lifespan as indicated by the lifespan filter algorithm.

8. A non-transitory computer readable medium storing instructions which, when executed by at least one processor, cause the at least one processor to:
receive, from a client device, a record query indicating genealogical parameters for searching a genealogical record database;
determine, utilizing a lifespan filter algorithm to process the genealogical parameters of the record query, a query lifespan corresponding to the genealogical parameters of the record query;
determine, utilizing the lifespan filter algorithm to process a candidate record from a plurality of candidate records stored within the genealogical record database by analyzing relative-data fields indicating dates associated with life events for relatives of the candidate record, a record lifespan corresponding to genealogical parameters of the candidate record; and
generate, based on the query lifespan and the record lifespan, a query result comprising the candidate record to provide to the client device in response to the record query.

9. The non-transitory computer readable medium of claim 8, further storing instructions which, when executed by the at least one processor, cause the at least one processor to determine the plurality of candidate records as records stored in the genealogical record database that include at least one matching genealogical parameter with the record query.

10. The non-transitory computer readable medium of claim 8, further storing instructions which, when executed by the at least one processor, cause the at least one processor to determine the record lifespan by analyzing a relative-data field included within the candidate record, the relative-data field indicating timing data for a life event of a relative of an individual represented by the candidate record.

11. The non-transitory computer readable medium of claim 8, further storing instructions which, when executed by the at least one processor, cause the at least one processor to determine the record lifespan according to a buffer metric indicating an error window for dates of the life events for the relatives of the candidate record.

12. The non-transitory computer readable medium of claim 8, further storing instructions which, when executed by the at least one processor, cause the at least one processor to determine the record lifespan based on a possibly-living range indicating a timespan from an earliest-possible birth year to a latest-possible death year indicated by the life events for the relatives of the candidate record.

13. The non-transitory computer readable medium of claim 8, further storing instructions which, when executed by the at least one processor, cause the at least one processor to order the candidate record within the query result based on an amount of lifespan overlap between the record lifespan and the query lifespan.

14. The non-transitory computer readable medium of claim 8, further storing instructions which, when executed by the at least one processor, cause the at least one processor to provide the query result for display on the client device.

15. A system comprising:
one or more memory devices; and
one or more processors coupled to the one or more memory devices, wherein the one or more processors are configured to cause the system to:
receive, from a client device, a record query indicating genealogical parameters for searching a genealogical record database;
determine, utilizing a lifespan filter algorithm to process the genealogical parameters of the record query, a query lifespan corresponding to the genealogical parameters of the record query;
determine, utilizing the lifespan filter algorithm to process a candidate record from a plurality of candidate records stored within the genealogical record database by analyzing relative-data fields indicating dates associated with life events for relatives of the candidate record, a record lifespan corresponding to genealogical parameters of the candidate record; and
generate, based on the query lifespan and the record lifespan, a query result comprising the candidate record to provide to the client device in response to the record query.

16. The system of claim 15, wherein the one or more processors are configured to cause the system to generate the query result to include the candidate record based on determining that the record lifespan overlaps the query lifespan by at least a threshold amount.

17. The system of claim 15, wherein the one or more processors are configured to cause the system to:
determine a possibly living range of a relative associated with the candidate record based on the relative-data fields; and
determine, as part of the record lifespan of the candidate record and based on the possibly-living range of the relative, a maximum birth date indicating a latest possible year of birth for an individual represented by the candidate record.

18. The system of claim 15, wherein the one or more processors are configured to cause the system to:
determine lifespan data of a relative associated with the candidate record based on the relative-data fields; and
determine, as part of the record lifespan of the candidate record and based on the lifespan data of the relative, one or more of a possibly-living range, a maximum birth date, or a minimum death date.

19. The system of claim 15, wherein the one or more processors are configured to cause the system to determine the record lifespan by:
determining, from the relative-data fields, a set of relative lifespans for relatives associated with the candidate record; and
determining the record lifespan based on the set of relative lifespans.

20. The system of claim 15, wherein the one or more processors are configured to cause the system to filter out, from the record query, one or more candidate records with record lifespans that do not overlap the query lifespan by at least a threshold amount.
